(19) United States
(12) Patent Application Publication
(10) Pub. No.: US 2010/0185784 A1
(43) Pub. Date: Jul. 22, 2010

(54) AUTOMATIC ADDRESS ASSIGNMENT FOR COMMUNIATION BUS

(75) Inventors: Robert Henri De Nie, Culemborg (NL); Alejandra Navarro Lecina, Roermond (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/669,042

(22) PCT Filed: Jul. 16, 2008
(86) PCT No.: PCT/IB2008/052861

§ 371 Date: Jan. 14, 2010

(30) Foreign Application Priority Data
Jul. 20, 2007 (EP) 07112871.4

(51) Int. Cl. G06F 3/00; G06F 13/00; G06F 11/22

(52) U.S. Cl. 710/9; 710/111; 714/5; 714/E11.146; 710/305

(57) ABSTRACT

A system comprises a plurality of electronic devices connected to a bus in operational use. For automatic address configuration of the devices, the devices are daisy-chained. In the daisy-chain, a preceding one of the devices transfers its address to a next one of the devices, and the latter determines its own address via an offset with respect to the address received.

### FIELD OF THE INVENTION

The invention relates to a system comprising a plurality of electronic devices connected to a bus in operational use, to a device for use in such a system and to a method of configuring the addresses of the devices in such a system.

### BACKGROUND ART

Consider a plurality of, say, eight or more devices, e.g., integrated circuits or electronic apparatus comprising an integrating circuit, that are to be controlled via a bus, e.g., an I²C bus, an SPI bus or a parallel I/O bus, etc. If the bus lacks in its protocol a mechanism for assigning addresses to the devices, it becomes tedious to assign unique device addresses to each and every device connected to the physical bus. It usually takes a significant number of programmable pins at each of the devices, or a few multi-level pins, or special selection circuitry, to solve the problem of assigning unique device addresses to circuits connected to such bus. In all these cases the PCB layout becomes more cumbersome, especially if the relation between position and address is to be known, as is the case, for instance, in matrix-oriented display devices or light emitting devices.

### SUMMARY OF THE INVENTION

The invention provides an efficient approach to the solution of configuring a system comprising a plurality of electronic devices connected to a bus in operational use of the system. In the system of the invention, the devices are also connected or connectable to one another, during configuring respective addresses for respective ones of the devices, so as to form a daisy-chain. Each of the devices comprises a bus interface for communicating with the bus, an input and an output. During configuring, each next one of the devices in the daisy-chain has its input connected to the output of a preceding one of the devices. Each respective one of the devices has respective means for determining the respective address. The means of each next device is operative to determine a next address based on an offset with respect to a previous address received from the preceding device, and to supply the next address at its output. The offset can be unity or another value, or can, e.g., be programmed in per device, e.g., manually or, preferably, via the bus or via another communication medium, before configuring the addresses.

In an embodiment of the system, a pair of successive ones of the devices is interconnected in the daisy-chain through a bit transmission channel, and each next one of the devices has a first shift register for receiving the previous address and a second shift register to supply the next address. The bit channel can simply be a single wire so as to keep the system's interconnections simple.

In a further embodiment, at least a specific one of the devices comprises further means configured to connect the input of the specific device to the output of the specific device upon detection of a failure in the means, first-mentioned, to determine the address of the specific device. This further means then functionally locks the specific device out of the daisy chain in the address configuration mode. For example, in case of a hardware implementation of the means to determine the specific address, a malfunctioning of the power supply to the device's circuitry or specifically to the means first-mentioned, may cause a switch to connect the specific device's input and output.

The invention also relates to an electronic device for use in such a system. Such a device comprises an interface to a bus; an input and an output; and means operative to determine a first digital quantity based on a second digital quantity received at the input and on an offset with respect to the second digital quantity, and operative to supply the first digital quantity at its output. Again, the offset can have pre-determined value, e.g., unity. In an embodiment, the input is a serial bit input, and the output is a serial bit output, so as to keep the interconnections between the devices simple. The device then has a first shift register for serially receiving the second digital quantity and a second shift register to serially supply the first digital quantity.

The invention further relates to a method of configuring a system having a plurality of electronic devices connected to a bus in operational use of the system. Each of the devices has a bus interface and an input and an output. For configuring respective addresses for respective ones of the devices, the method comprises connecting each next one of the devices with its input to the output of a preceding one of the devices so as to form a daisy-chain; determining for each next device a next address based on an offset with respect to a previous address received from the preceding device; and supplying the next address at the output of the next device.

Such a method may be commercially relevant to the system operator who needs to re-configure the system more than once. For example, the system is comprised in a lighting system for a stage performance, an exhibition, or another public event. In this scenario, each device comprises a lighting fixture that can be individually controlled via the bus. Each event may require another configuration of devices (different numbers of devices, different sequence of devices, changing the physical locations of the same devices, etc.). As another example, the system allows a modular configuration wherein the invention enables the automatic address assignments per configuration.

### BRIEF DESCRIPTION OF THE DRAWINGS

The invention is explained in further detail, by way of example and with reference to the accompanying drawing, wherein:

FIG. 1 is a block diagram of a bus system with devices connected to a bus wherein the invention is applied;

FIGS. 2-4 are diagrams of known devices for the bus system of FIG. 1;

FIG. 5 is a diagram of a device in the invention;

FIG. 6 is a diagram of the bus system in the invention in operational use; and

FIG. 7 is another diagram of a device in the invention.

Throughout the Figures, similar or corresponding features are indicated by same reference numerals.

### DETAILED EMBODIMENTS

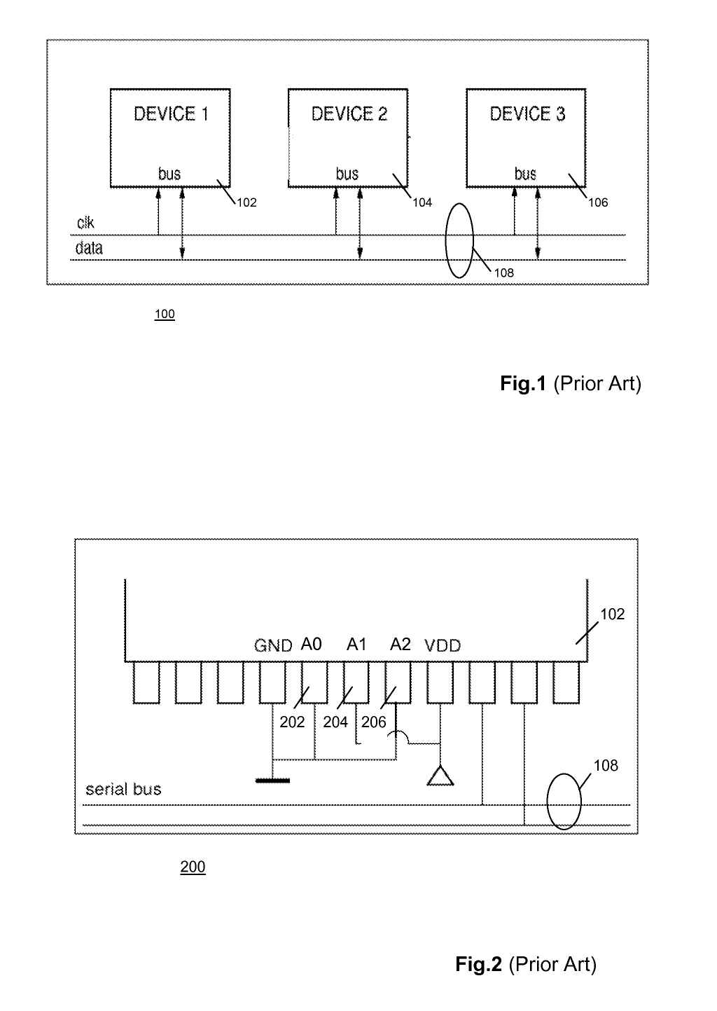

FIG. 1 is a block diagram of a system 100 wherein a plurality of electronic devices 102, 104, . . . , and 106 are connected to a bus 108, e.g., an I²C bus. As mentioned above, other types of buses can be used. Devices 102-106 could be of an identical type, e.g., luminaires with controllable LEDs. The problem considered relates to configuring system 100 by means of assigning addresses to devices 102-106.

FIG. 2 is a block diagram 200 of device 102 to illustrate aspects of a first known manner of assigning addresses using the bus configuration mentioned above. The address assignment in FIG. 2 is based on providing a number of N input pins, N being equal to the required number of programmable bits in the address, which can in operational use be tied either to ground (GND) or to a supply voltage (VDD). This yields 2^{N} possible addresses.

Accordingly, for N=8 different addresses already 3 extra pins, pins 202, 204 and 206 are needed.

FIG. 3 is a block diagram 300 of device 102 to illustrate aspects of a second known manner of assigning addresses using the bus configuration mentioned above. The address assignment in FIG. 3 is based on the use of multi-level inputs. Within the voltage range of supply voltage VDD one can define, e.g., three voltage levels such that on the outside of device 102 voltages can be defined by means voltage dividers connected between ground GND and supply voltage VDD. In the example shown, resistors 302 and 304 forms one voltage divider, and resistors 306 and 308 form another voltage divider. Disadvantages of this approach reside in, e.g., the circuitry required to define and apply the different voltage levels and ways to guarantee that the levels remain valid over, e.g., the supply voltage range and temperature range. It costs, however, only two pins to provide for 16 possible addresses as shown.

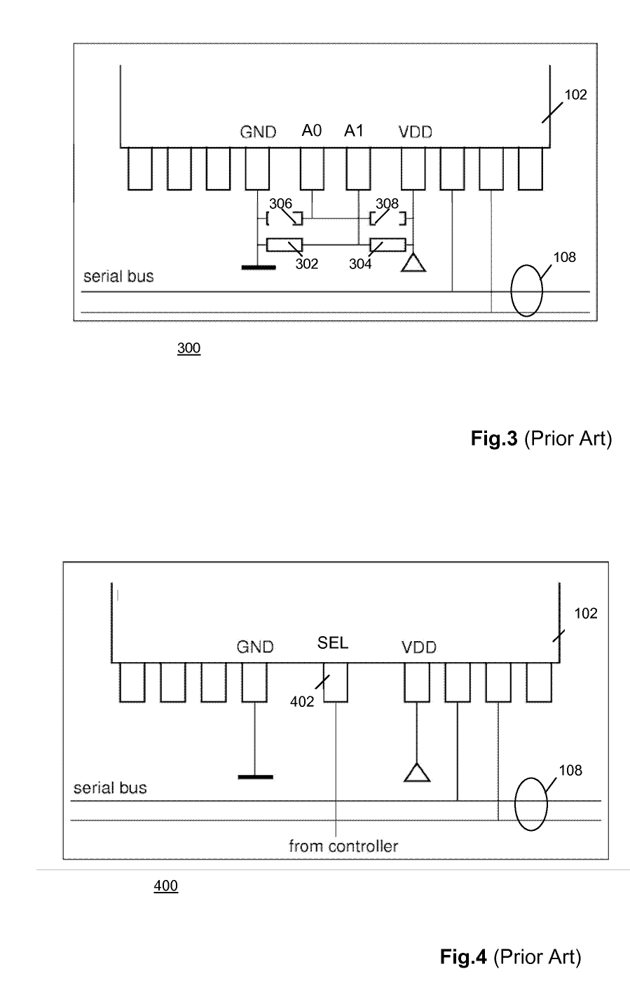

FIG. 4 is a block diagram 400 of device 102 to illustrate aspects of a third known manner of assigning addresses using the bus configuration mentioned above. The address assignment in FIG. 4 is based on having a “chip select” pin 402 on device 102 and a microcontroller (not shown) that has a plurality of output ports. The microcontroller can select device 102 via activating pin 402, and device 102 then acts on a command given via bus 108, whereas the non-selected ones of devices 102-106 remain inactive. Major disadvantages here are the number of additional wires needed for selecting one or more of devices 102-106, and the number of available output ports on the microcontroller, which needs at least to be equal to the number of devices 102-106 in operational use of system 100.

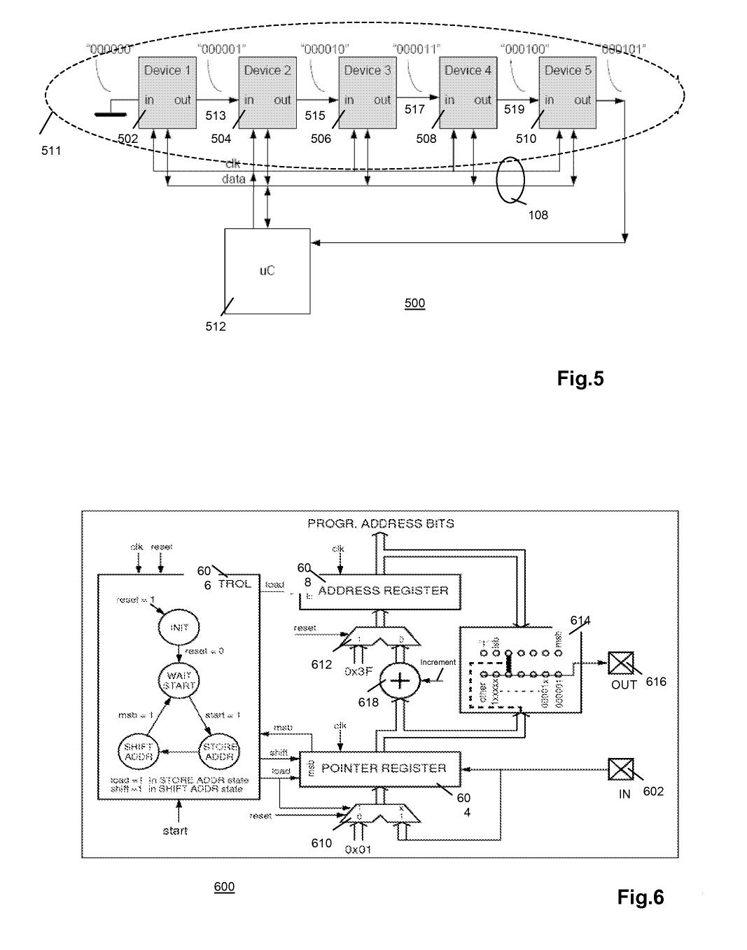

The invention addresses the problem of how to automatically assign, preferably consecutive, addresses to devices 102-108 in a bus configuration as discussed above, and provides an alternative solution as is discussed below with reference to FIG. 5 and FIG. 6.

FIG. 5 is a block diagram of a system 500 configured for implementing the addressing scheme. System 500 comprises a plurality of devices 502, 504, 506, 508, . . . , and 510 in a daisy-chain configuration 511 and connected to bus 108. Respective pairs of successive devices 502-510 are connected through respective transmission channels 513, 515, 517 and 519. In an embodiment of the invention, channels 513-519 are serial bit transmission channels, e.g., single wires. System 500 comprises a system controller 512 that controls devices 502-510 in operational use via bus 108. System controller 512 is configured to monitor an output of the last device in the chain, here, device 510 during address configuration of system 500. In order to explain the configuration in further detail, reference is made to FIG. 6.

FIG. 6 is a block diagram 600 of any of devices 502-510 designed according to the invention. With respect to the configuring of the addresses in system 500, devices 502-510 have a similar architecture. A serial input pin 602 is connected to a register 604. Register 604 can be loaded in parallel, be shifted serially or can hold its data, under control of a device controller 606. Controller 606 also delivers control signals for a second register 608 and for multiplexers 610 and 612. The outputs of registers 604 and 608 are connected to an output selector 614. Selector 614 supplies an output signal in order to drive a serial output pin 616. The output of register 604 is connected, via a stage 618 that implements an “increment” functionality, to multiplexer 612. The increment value (or offset) is, e.g., unity or another suitable value. The increment value (or offset) can be fixed, e.g., by the manufacturer of devices 502-512, or may be set or programmed by the end user through a suitable interface (not shown). The output bits of register 608 constitute the programmable address bits required. Furthermore, controller 606 receives a signal “start” from system controller 512 and the most-significant bit (MSB) of register 604. Registers 604 and 608, and controller 606 are driven by the same clock signal “clk”.

During a reset carried out for devices 502-510 in parallel, controller 608 is put into an “Init” state. In this state, register 604 is loaded with bits having the logic values present at input 602, and register 608 is loaded with all logic ones. This means the first device in the daisy-chain (here device 502), having its input 602 connected to ground, will get all zeroes in its register 604. All other devices 504-510, having their inputs 602 connected to the output 616 of the previous device in the chain, will all have logic ones in their register 604, since all registers 608 contain only logic ones, resulting in a logic one at output 616, independent of the contents of register 604, due to the construction of selector 614.

As soon as the reset period is finished, controller 606 goes to a “Wait Start” state. When signal “start” is asserted, controller 606 will change state to a “Store Addr” state, in which a signal “load” is asserted. As a consequence of this, register 608 will be loaded with the current value of register 604 incremented by a certain value, e.g., unity, and register 604 gets at the same time initialized with hex value 0×01, i.e., a decimal 1.

At this point the programmable address bits of device 502 are defined and will always have the value logic one, whereas the programmable address bits of the other devices 504-510 in the chain are still all logic ones.

During the next clock cycle, controller 606 will move to the “Shift Addr” state. In this state, the signal “shift” is asserted, causing the bits in register 604 to be shifted from the input 602 to the MSB position. Since the least-significant bit (LSB) was initialized with a logic one (see 0×01), there will always be a logic one eventually shifting into the MSB position of register 604. During the shifting process the value of register 608 remains unchanged. While the logic one in register 604 is shifting, selector 614 will supply the values of the bits in register 608 to output 616, starting with the MSB of register 608. Selector 614 is a priority decoder: the most significant logic one in the bits of register 604 determines which bit of register 608 is routed to output 616. That is, the logic one of the bits in register 604 with the higher bit rank among all logic ones in register 604 determines the routing.

Since each of devices 504-510 is connected to its predecessor, register 604 will be filled with the programmable bits of its predecessor during the shift action, except for first device 502, whose register 604 will always stay filled with logic zeroes. As soon as the MSB of register 604 turns a logic one, controller 606 will leave the “Shift Addr” state and return to the “Wait Start” state. The whole cycle will be executed again on reception of the next start command. The start command is to be derived from the device's interface to bus 108. As an example, one can think of the start condition inherently present in the I²C protocol, but it should normally be possible to derive such command from any applicable bus protocol when a transmission is initiated.

In other words, per cycle of operations, representing the sequence of the states “Store Addr” (with the “start” command), “Shift Add” (with “shift” command), and “Wait Start”, the register 608 of a next one of devices 502-510 is adopting the value represented by the bits in register 608 of a previous one of devices 502-510, incremented by an offset of, e.g., unity in this example. The bits of an address of a device to be forwarded to a next device in the chain are shifted out of the device and into the next device under serial clock control so as to be able to use only a single bit transmission channel (e.g., a single wire). Other offsets may be chosen. For example, devices 502-510 may be using only such offsets and initialization values so as to generate only even or only odd addresses. As another example, the addresses of consecutive ones of devices 502-510 may adopt successive addresses formatted in the Gray code, so that successive addresses only differ by a single bit. This may be interesting to a system of devices that are to be activated or deactivated in the order wherein they have been connected to bus 108.

The programmable bits of devices 502-510 in the chain will thus get defined device after device, in the order wherein they have been concatenated in daisy-chain 511, upon each start of a transmission. Since the first device already gets defined at the start of the first transmission, it can be immediately addressed and communicated with. By organizing the transmission scheme in such a way that the order of addressing is equal to the order in the chain, no time will be lost for the address assigning process itself and no overhead is wasted in bus controller 512.

By observing the output of last device 510 in the chain controller 512 will be able to determine when it is addressing the last device. The output will be a logic high until register 608 does not contain all logic ones anymore. So, when a logic low is detected the device is addressed. This is only true, of course, if the aforementioned transmission scheme has been executed. Controller 512 will now be able to check whether all devices 502-510 are present.

It should be noted that the programmable address combination of all logic zeroes cannot be used. The combination of all logic ones can be used, but if used, the detection of last device 512 by observing output 616 is no longer possible. In another embodiment, an additional register (not shown) can be used to store the programmed address of register 608. Register 608 can then be emptied while shifting out the bits, and register 604 can be filled by shifting in the bits at input 602. Output 616 is then to be connected with the MSB of register 608, so that selector 614 can be omitted.

The invention can be used in any application where a need exists for automatic address assigning of many circuits hooked up to a bus, whereby the addresses are solely determined by the order of the devices in the daisy-chain. As such the invention can be used in LED based lighting applications wherein the devices are light fixtures having LEDs for controllable lighting. Furthermore the invention can be used in LCD backlighting wherein the backlighting is segmented using the system discussed above, and wherein a device is controlled via the bus interface to emit light controllably. Similarly, the invention can be used in a flat panel display ambient lighting configuration. Furthermore the invention can be used in automotive lighting, wherein a plurality of light sources must be controlled from a single vehicle control unit. The invention also can be used in general Point of Load controllers, where its modular approach is beneficial to implement scalable and flexible systems.

In FIG. 6, various components, e.g., components 604, 608, 610, 612, and 614 have been described as if they were implemented in hardware. It is clear that the functionalities of these components could as well be implemented fully in software and integrated, e.g., as part of controller 606 that now has been drawn separately, or as gate-array, etc.

Before executing the address configuration as discussed above in a system wherein components 604, 608, 610, 612, and 614 have been implemented in (programmable) software, it may be advisable for the operator to roughly know the number of devices in the daisy-chain. The operator can then use bus controller 512 to set the size of registers 604 and 608 and the input range and output range of selector 614 so as to accommodate the number of bits necessary to carry out the address configuration scheme for this particular number of devices.

When the automatic address assignment mechanism is used in system 500 and one of devices 502-510 breaks down during address configuration or has broken down beforehand, the address assignment may not be successfully completed. If one or more of devices 502-510 is broken, at least the devices downstream of the last broken device in the chain will be lost from the point of view of controller 512, although the downstream devices are still available and operational with respect to bus 108.

Below, a way is described to avoid problems if one or more of devices 502-510 connected in the daisy chain malfunctions with regard to the address generation.

When using the address generation mechanism, discussed above, in a long chain of devices, first device 502 with its input connected to ground will take address 1 in the chain (1 added to the device base address, for example 0×41 in a 6 bit configurable device). Next device 504 connected in the chain will see a 1 at the input and will configure itself with address 2 in the chain (0×42 in the same previous example). Device 504 will supply at its output address 2 and next device 506 will configure itself with address 3 and so on. The output of last device 510 will be connected to controller 512. As soon as a zero is detected by controller 512, controller 512 will know that the address assignment has finished and can start addressing devices 502-510 in operational use of system 500.

Assume that, after proper initialization, one of devices 502-510, e.g., device 506 in the middle of the chain, breaks down, the following problems may occur. If the malfunctioning is such that the supply (VDD), powering the components involved in the automatic address configuration and in the interface to bus 108, is still available, device 506 will still get an address. Device 506 will be accessible by controller 512 and controller 512 will be able to detect (e.g., via register access) that device 506 is not longer properly working (e.g., it is not emitting light in the case of a luminaire). In this case the broken device does not disturb the proper addressing operation of system 500.

If device 506 breaks down in such a way that the circuitry involved in the automatic addressing configuration and in the interface is not powered anymore, the output 616 of device 506 will be grounded. Then devices 508 and 510 downstream after the broken one will start again the count-up address mechanism. In the worst case scenario, half of the devices have the same addresses as the other half (or are not addressable at all) and generate a bus addressing conflict. The addressing by controller 512 becomes a problem and system 500 as a whole becomes inoperative. To solve this problem, a mechanism can be implemented to connect input 602 of failed device 506 to output 616 of failed device 506.

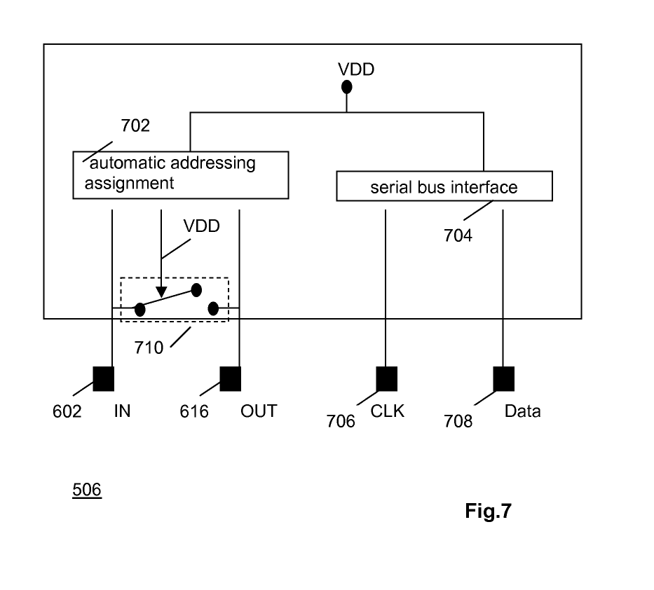

FIG. 7 is a block diagram of any of devices 502-510, e.g., device 506, being equipped with such a mechanism. Device 506 comprises a block 702 representing the components involved in the automatic address assignment process of the invention as described above, e.g., components 604, 606, 608, 610, 612 and 614. Device 506 also comprises circuitry for operational use of device 506 including a interface 704 for connecting to bus 108 via a pin 706 for connection to clock line “clk” of bus 108 and a pin 708 for connection to data line “data” of bus 108. In the example shown, a switch 710 is located between pins 602 and 616. Switch 710 is controlled in such a way that it is open after proper initialization of device 506 and with a properly functioning power supply VDD, and closed otherwise. If power supply to block 702 is interrupted, e.g., through a failure of a circuit, switch 710 will lock device 506 out of the daisy-chain and the addressing process takes place as if device 506 were not there. Some embodiments may use standard bonding pads in their ICs for input 602 and output 616. In this case, the pads will have a protection diode to “gnd” if VDD is not present. As a result, the daisy-chain signals in channels 513-519 will not be able to reach their logic high level. This issue can be avoided by using pads without protection diodes to VDD.

With this solution, if an IC in system 500, e.g., a luminaire is broken, the chain will not be broken by the failed device. If the device is only partially broken, the power supply VDD remains available but cannot cause device 506 to function in operational use, e.g., device 506 does not emit light in the case of a luminaire application. The address assignment will still work and controller 512 will be able to detect afterwards that device 506 is not properly working, and can reprogram the other devices in order to get the total light flux output as in the situation wherein all devices in the system properly work. Accordingly, for a specific one of devices 502-506, the input of the specific device is connected to the output of the specific device if a malfunctioning is detected in the circuitry determining the address of the specific device, or in the circuitry supplying the address of the specific device at output 616 of the specific device.

1. A system comprising:
a plurality of electronic devices connected to a bus in operational use of the system, and connected to one another so as to form a daisy-chain during configuring respective addresses for respective ones of the devices,
wherein:
each of the electronic devices comprises:
a bus interface for communicating with the bus;
an input and an output;
wherein each next one of the devices in the daisy-chain has its input connected to the output of a preceding one of the devices;
wherein each respective one of the devices has respective determining means for determining the respective address; and
the determining means of each next device is operative to determine a next address based on an offset with respect to a previous address received from the preceding device, and to supply the next address at its output.

2. The system of claim 1, wherein the offset is unity.

3. The system of claim 1, wherein:
a pair of successive ones of the devices is interconnected in the daisy-chain through a serial bit transmission channel; and
each next one of the devices has a first shift register for receiving the previous address and a second shift register to supply the next address.

4. The system of claim 1, wherein at least a specific one of the devices has further connecting means configured to connect the input of the specific device to the output of the specific device upon detection of a failure in the determining means to determine the address of the specific device.

5. An electronic device comprising:
a bus interface;
an input and an output; and
determining means operative to determine a first digital quantity based on a second digital quantity received at the input and on an offset with respect to the second digital quantity, and operative to supply the first digital quantity at its output.

6. The device of claim 5, wherein the offset is unity.

7. The device of claim 5, wherein:
the input is a serial bit input;
the output is a serial bit output; and
the device has a first shift register for receiving the second digital quantity and a second shift register to supply the first digital quantity.

8. The device of claim 5, comprising further connecting means configured to connect the input of the specific device to the output of the specific device upon detection of a failure in the determining means to determine an address of the device.

9. A method of configuring a system having a plurality of electronic devices connected to a bus in operational use of the system, wherein
each of the devices has a bus interface, an input and an output for configuring respective addresses for respective ones of the devices, the method comprises:
connecting each next one of the devices with its input to the output of a preceding one of the devices so as to form a daisy-chain,
determining for each next device a next address based on an offset with respect to a previous address received from the preceding device; and
supplying the next address at the output of the next device.

10. The method of claim 9, further comprising, for a specific one of the devices connecting the input of the specific device to the output of the specific device if a malfunctioning is detected in at least one of determining of the address of the specific device, and in the supplying of the address of the specific device at the output of the specific device.
